(19) United States
(12) Patent Application Publication
(10) Pub. No.: US 2012/0297948 A1
(43) Pub. Date: Nov. 29, 2012

(54) Method to supply water to tile saw blade

(76) Inventor: George Allen Kenton, Cave Creek, AZ (US)

(21) Appl. No.: 13/068,826

(22) Filed: May 23, 2011

(51) Int. Cl. B26D 7/08; F16L 27/00; F16K 31/02

(52) U.S. Cl. 83/168; 251/129.01; 251/129.03

(57) ABSTRACT

This invention provides an improved method of supplying cooling water for the blade of a power saw use to cut tile, stone or brick.

### BACKGROUND OF THE INVENTION

Most tile saws use a small water pump that either is submersed in a catch pan below the tile saw blade or in a separate bucket of water. The water is delivered to the blade by means of small plastic tubing directed to the cutting edge. The tile saw usually has a separate AC outlet by which power is supplied to the water pump when the switch to the saw blade motor is turned on.

The problem with placing the water pump in the pan below the blade is, tile dust and debris from the cuttings in recirculated water will in short time clog and or damage the pump. Placing the water pump in a separate bucket of clean water requires constant refilling of the bucket from a source of water, so as the pump does not go dry and loose its priming, which could also shorten the life of the pump. Both of these scenarios create more work for the operator and result in lower production time.

### SUMMARY OF THE INVENTION

This utility eliminate the use of a water pump to supply water to a tile or brick cutting power saw blade by means of an electric solenoid water valve such as used in residential sprinkler systems and fittings to attach to a common garden hose and a supply side needle valve. The valve solenoid is activated by a low voltage power supply attached to the existing tile saws ac outlet used by the pump being replaced. By use of a needle valve, water flow can be adjusted and exactly simulate the flow from the small pump that most saws are equipped with. Also because the valve solenoid is powered from a low voltage power adapter there is no hazardous voltages that could come into contact with the water, thus making a safer assembly.

### DETAILED DESCRIPTION OF THE INVENTION

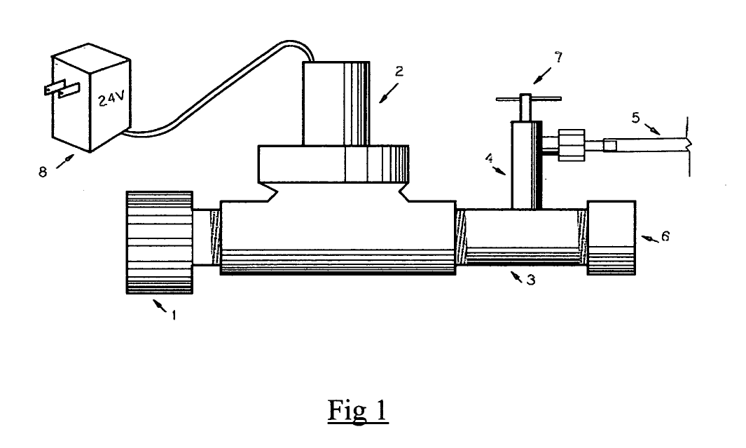

Referring to FIG. 1, This utility is comprised of the following parts.

(1) A female gender threaded fitting used to connect a valve to a common garden hose.

(2) Solenoid and water valve assembly of the type used in a residential sprinkler system.

(3) Threaded pipe nipple attached the valve (2) used for attachment of needle valve (4).

(4) Needle valve attached to the pipe nipple (3) and connected to supply tube (5).

(5) Existing supply tube attached to the tile saw.

(6) Cap on end of the pipe nipple (3).

(7) Needle valve handle to adjust water flow to saw blade.

(8) 24 volt or some low voltage power supply adapter to power the valve solenoid.

A common type garden hose is attached to the input side of an electric solenoid water valve (2) by means of a female swivel MNPT adapter (1). The electric solenoid water valve is attached to a pipe nipple and cap that enables a needle type valve (4) to be attached to the output side of the said valve. The water flow can be adjusted with the handle (7) of needle valve (4) for proper flow into the existing water tubing (5) going to the blade assembly of the tile saw. Power is supplied to the electric solenoid valve by a low voltage power adapter (8) connected to the existing pump power outlet of the tile saw.

1. A means to supply clean non-recirculated water to the blade of a tile saw for cooling purposes comprising of an electric operated solenoid type water valve connected to a garden hose with a swivel type hose fitting and the volume of the water flow controlled by use of a needle or ball type valve attached to the output side of said electric solenoid water valve, thus supplying water by means of the existing tubing supplying a saw designed to cut tile, stone or bricks.

2. A low voltage power adapter that supplies energy to an electric solenoid type water valve that is used in place of the water pump that is employed by many power saws used to cut tile, stone or brick and connected to a common garden hose and flow controlling type needle or ball valve for supplying the water to the tile saw.

3. An electric solenoid operated water valve that outputs to a needle or ball type flow control valve at one end and a female gender type treaded swivel fitting for the purpose of attaching to a common garden hose at the other end.

4. A plastic female swivel garden hose thread adapter connected to the input side of an electric solenoid valve that is connected to a pipe nipple and cap on the output side and ported for a needle or ball type manual adjusting flow control valve.
